(19) United States
(12) Patent Application Publication
(10) Pub. No.: US 2022/0063261 A1
(43) Pub. Date: Mar. 3, 2022

(54) PRINTING APPARATUS AND PRINT PRODUCING METHOD

(71) Applicant: SEIKO EPSON CORPORATION, Tokyo (JP)

(72) Inventor: Tomonori ISHIBASHI, Shiojiri (JP)

(21) Appl. No.: 17/462,062

(22) Filed: Aug. 31, 2021

(30) Foreign Application Priority Data
Sep. 2, 2020 (JP) 2020-147617

(51) Int. Cl. B41J 2/045; B41J 2/165

(52) U.S. Cl. CPC B41J 2/0451; B41J 2002/16502; B41J 2/16517; B41J 2/04581

(57) ABSTRACT

A printing apparatus that eliminates an abnormality, which deteriorate printing quality, at timing based on a state of the abnormality and requested printing quality.

The present application is based on, and claims priority from JP Application Serial Number 2020-147617, filed Sep. 2, 2020, the disclosure of which is hereby incorporated by reference herein in its entirety.

### BACKGROUND

### 1. Technical Field

The present disclosure relates to a printing apparatus and a print producing method.

### 2. Related Art

There has been known a method of, in a printing apparatus, detecting a defective nozzle out of a plurality of nozzles for ejecting ink and suppressing image quality deterioration due to the defective nozzle (for example, JP-A-2020-89977 (Patent Literature 1) and JP-A-2020-97123 (Patent Literature 2)).

Operation for eliminating a defective nozzle consumes a time. When suction, flushing, or the like is performed in order to eliminate clogging, ink is consumed. There could be various situations such as a situation in which it is desired to improve printing quality with the eliminating operation even if the time or the ink is consumed and a situation in which it is desired to obtain a print early even if printing quality is not high. Such various situations have not been considered. That is, the operation for eliminating the defective nozzle has been inflexible.

### SUMMARY

A printing apparatus according to an aspect of the present disclosure includes: a printing head configured to eject ink from a plurality of nozzles to perform printing; a detecting mechanism configured to detect clogging of the nozzles; an eliminating mechanism configured to eliminate the clogging of the nozzles; and a processor configured to cause the printing head to perform the printing according to a printing job. When the clogging of the nozzles is detected, the processor determines based on a state of the clogging of the nozzles and requested printing quality whether to eliminate the clogging of the nozzles, when determining to eliminate the clogging of the nozzles, causes the eliminating mechanism to eliminate the clogging of the nozzles during the printing of the printing job, and, when determining not to eliminate the clogging of the nozzles, does not cause the eliminating mechanism to eliminate the clogging of the nozzles during the printing of the printing job.

A print producing method according to an aspect of the present disclosure is a print producing method in a printing apparatus including a printing head configured to eject ink from a plurality of nozzles to perform printing, a detecting mechanism configured to detect clogging of the nozzles, an eliminating mechanism configured to eliminate the clogging of the nozzles, and a processor configured to cause the printing head to perform the printing according to a printing job. The print producing method including, when the clogging of the nozzles is detected, the processor determining based on a state of the clogging of the nozzles and requested printing quality whether to eliminate the clogging of the nozzles, when determining to eliminate the clogging of the nozzles, causing the eliminating mechanism to eliminate the clogging of the nozzles during the printing of the printing job, and, when determining not to eliminate the clogging of the nozzles, not causing the eliminating mechanism to eliminate the clogging of the nozzles during the printing of the printing job.

### BRIEF DESCRIPTION OF THE DRAWINGS

FIG. 1 is a block diagram of a printing apparatus.

FIG. 2 is a schematic diagram showing an array of nozzles.

FIG. 3 is a diagram showing an example of clogged nozzles.

FIG. 4 is a diagram showing an example of a method of added points when clogged nozzles are present.

FIG. 5 is a diagram showing an example of point addition scale factors for each of ink colors.

FIG. 6 is a diagram showing allowable levels.

FIG. 7 is a diagram showing a point addition example.

FIG. 8 is a flowchart of nozzle inspection processing.

### DESCRIPTION OF EXEMPLARY EMBODIMENTS

Embodiments of the present disclosure are explained according to order described below.

(1) Configuration of a printing apparatus

(2) Nozzle inspection processing

(3) Other embodiments

### (1) Configuration of a Printing Apparatus

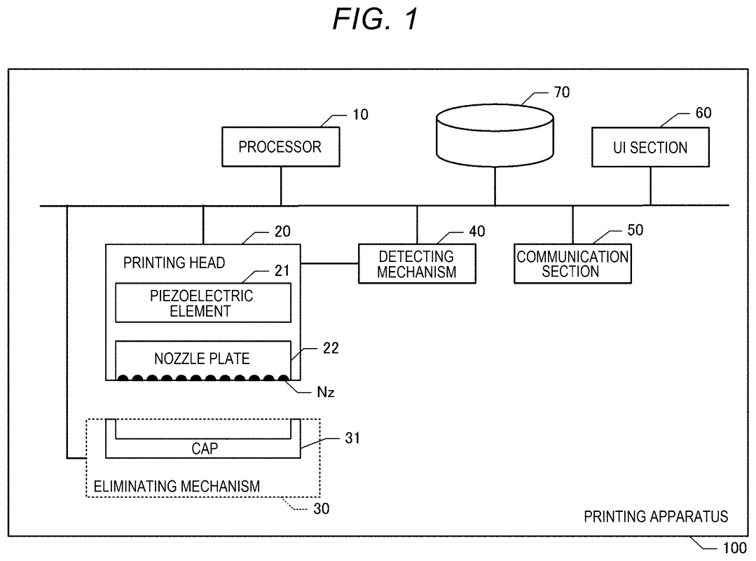

FIG. 1 is a block diagram showing the configuration of a printing apparatus 100 according to an embodiment of the present disclosure. The printing apparatus 100 includes a processor 10, a printing head 20, an eliminating mechanism 30, a detecting mechanism 40, a communication section 50, a UI section 60, and a nonvolatile memory 70.

The processor 10 includes a CPU, a RAM, a ROM, and the like, not shown in FIG. 1. The processor 10 can execute various programs recorded in the nonvolatile memory 70 to control the sections of the printing apparatus 100. The processor 10 may be configured by a single chip or may be configured by a plurality of chips. For example, an ASIC may be adopted instead of the CPU. The CPU and the ASIC may cooperate.

The communication section 50 includes a communication interface for communicating with an external device according to wired or wireless various communication protocols. The communication section 50 includes an interface for communicating with various removable memories attached to the printing apparatus 100. The printing apparatus 100 is capable of communicating with a printing job generation apparatus such as a personal computer, a smartphone, or a tablet computer via the communication section 50. Printing job data transmitted from the printing job generation apparatus is temporarily stored in the nonvolatile memory 70.

The UI section 60 includes a touch panel display and various keys, switches, and the like. The touch panel display includes a display panel that displays various kinds of information based on the control by the processor 10 and a touch detection panel laid on the display panel. The touch display panel detects touch operation by a human finger or the like. The processor 10 can acquire operation content of a user via the UI section 60. The processor 10 can display various kinds of information on the display of the UI section 60 and notify the information to the user.

The printing head 20 includes a piezoelectric element 21, a flat nozzle plate 22, and a plurality of nozzles Nz. The printing head 20 receives supply of ink from a not-shown ink tank and ejects ink droplets of the ink from the nozzles Nz. The nozzles Nz are arrayed on the flat nozzle plate 22 opposed in parallel to a not-shown printing medium. The respective nozzles Nz and not-shown ink chambers communicate. The ink is supplied to the ink chambers from the ink tank. A driving pulse output from a not-shown driving signal generation circuit is applied to the piezoelectric element 21 provided for each of the ink chambers. The piezoelectric element 21 is mechanically deformed by the driving pulse and pressurizes and depressurizes the ink in the ink chamber to thereby eject the ink droplets from the nozzles Nz.

The printing head 20 is mounted on a not-shown carriage and reciprocates. A direction of the reciprocation is referred to as main scanning direction. The printing medium is conveyed by a not-shown conveying mechanism in a direction (referred to as sub-scanning direction, conveying direction, or the like) orthogonal to the main scanning direction. Inks of respective colors are ejected from the nozzles Nz in a process of moving the carriage in the main scanning direction, whereby an image can be printed on the printing medium. It is possible to form an image in any position in a printable range in the printing medium by repeating the conveyance of the printing medium by the conveying mechanism, the movement of the carriage, and the ejection of the ink from the printing head 20.

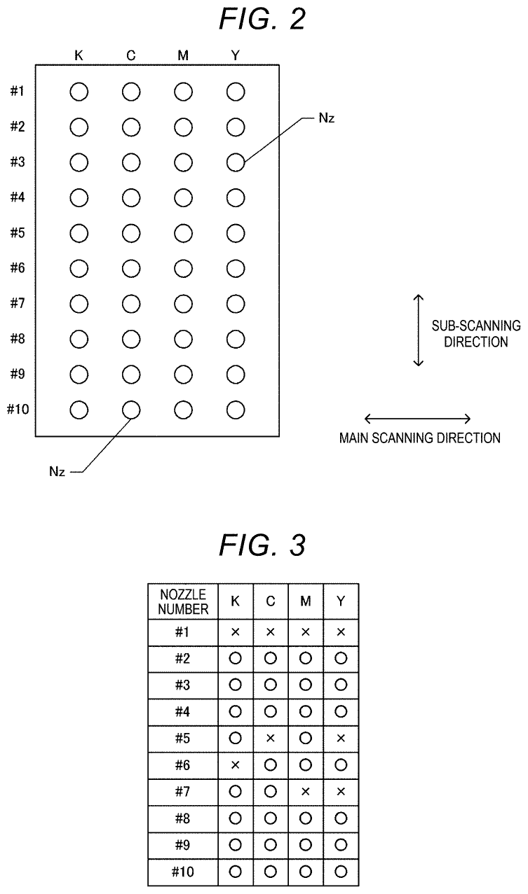

In this embodiment, the printing head 20 performs printing using inks of four colors of cyan (C), magenta (M), yellow (Y), and black (K). FIG. 2 is a schematic diagram of the nozzles Nz formed on the nozzle plate 22. As shown in FIG. 2, in this embodiment, the nozzles Nz are formed at a predetermined pitch in the sub-scanning direction. In this embodiment, ten nozzles Nz are formed in the sub-scanning direction. The nozzles Nz for the ink of the same color disposed side by side in the sub-scanning direction are referred to as nozzle row. In this embodiment, a K nozzle row, a C nozzle row, an M nozzle row, and a Y nozzle row are present. Identification information indicating ordinal numbers of the nozzles in the nozzle rows is associated with the nozzles Nz. In this embodiment, numbers are allocated in ascending order from the top to the bottom of the paper surface of FIG. 2. For example, K #1 indicates a first nozzle of the K nozzle row.

The detecting mechanism 40 detects clogging in the nozzles Nz. Since a consumed electric current changes according to a deformation amount in unit time of the piezoelectric element 21, when the ink is not normally ejected, an abnormality is seen in the deformation amount, that is, a current value per unit time of the piezoelectric element 21. During a nozzle inspection of the nozzles Nz, the detecting mechanism 40 monitors the current amount and detects clogging of the nozzles Nz. The processor 10 can identify, with the detecting mechanism 40, which nozzle in which row is clogged.

The eliminating mechanism 30 includes a cap 31 forming a space that the nozzle group faces and a not-shown mechanism for supporting the cap 31 and changing a position of the cap 31 with respect to the nozzle plate 22 of the printing head 20 according to a state of the printing apparatus 100. The cap 31 is disposed in a home position. The home position is a standby position where the printing head 20 stays on standby when the printing head 20 does not carry out printing. The cap 31 can perform capping when the carriage mounted with the printing head 20 moves to the home position. The cap 31 includes a bottom section and a sidewall section standing from peripheral edges of the bottom section and has a box shape, an upper surface of which opposed to the nozzle plate 22 is opened. During the capping, the nozzle group faces a space surrounded by the bottom section and the sidewall section.

In the bottom section, a sheet-like moisture retaining member made of a porous material such as felt or sponge is disposed. In this embodiment, continuously ejecting a default amount of ink droplets from the nozzles Nz is referred to as flushing operation. The ink hits the moisture retaining member during the flushing operation. Evaporation of an ink solvent from the nozzles Nz can be prevented by the moisture retaining member during the capping. A not-shown waste liquid tube is connected to the space of the cap 31. A not-shown suction pump is connected to the waste liquid tube. The operation of the suction pump is controlled by the processor 10. When the suction pump is operated in a state in which an opening edge in an upper part of the cap 31 adheres to the nozzle plate 22, a sucking operation for sucking the ink and air in the printing head 20 through the nozzles Nz can be carried out from the cap 31 side. In this embodiment, an eliminating operation for eliminating clogging of the nozzles Nz includes at least one of the flushing operation and the sucking operation.

When acquiring a printing job from the printing job generation apparatus via the communication section 50, the processor 10 causes the printing head 20 to perform printing according to the printing job. That is, the processor 10 determines, based on the printing job, timing for applying pulses to the nozzles and a type of the pulses to be applied and applies the pulses to the nozzles and causes the nozzles to eject the ink in a process of causing the carriage and the conveying mechanism to operate. In this embodiment, the processor 10 controls the detecting mechanism 40 to carry out a nozzle inspection every time printing of a default number of pages is executed. The user can set the default number of pages to any value. For example, in the case of cut paper, the nozzle inspection is carried out when ink ejection to a printing medium of an n-th page ends and before ink ejection to a printing medium of an n+1-th page is performed (n is an integer equal to or larger than 1). When the printing medium is roll paper, every time printing of a default number of image blocks is executed, the nozzle inspection is carried out after the printing of the image blocks ends and before printing of the next image block is started.

When clogging of the nozzles is detected by the nozzle inspection, the processor 10 determines based on a state of the clogging of the nozzles and requested printing quality whether to eliminate the clogging of the nozzles. The requested printing quality is printing quality set by the user in creating a printing job and stored in a header of the printing job but is not limited to this. For example, the requested printing quality may be calculated from other settings stored in the printing job such as a type of a printing medium or may be set in the printing apparatus. The requested printing quality may be calculated according to a type of an application program that generates image data used for creating the printing job. Further, the requested printing quality may be calculated based on one or a plurality of kinds of information among these kinds of information and information other than these kinds of information.

First, the processor 10 acquires identification information (nozzle rows and numbers) of clogged nozzles from the detecting mechanism 40 as a result of the nozzle inspection. The processor 10 calculates a score P_{SUM} indicating a state of the clogging of the nozzles in the printing head 20.

The score P_{SUM} indicating the state of the clogging of the nozzles in the printing head 20 is represented by a total of scores P calculated for each of the clogged nozzles in the printing head 20. A larger value of the score P_{SUM} indicates that the state of the clogging of the nozzles is worse and the printing quality could be deteriorated. FIG. 3 shows an example of the clogged nozzles in the printing head 20. In the example shown in FIG. 3, nozzles indicated by cross marks are the clogged nozzles. That is, first and sixth nozzles in the K row, first and fifth nozzles in the C row, first and seventh nozzles in the M row, and first, fifth, and seventh nozzles in the Y row are clogged. Nine nozzles in total are clogged in the printing head 20. Therefore, in the case of the example shown in FIG. 3, the score P_{SUM} indicating the state of the clogging of the nozzles in the printing head 20 is represented by a total of the scores P calculated for each of the nine nozzles.

The score P about certain one clogged nozzle is calculated as follows. That is, when an n-th nozzle in an X₁ row among X₁ to X₄ rows, which are nozzle rows, is clogged, the score P of X₁ #n is represented by the following Expression (1).

Score P of X₁ #n=(X₁α #n+X₂β #n+X₃β #n+X₄β #n)×color (1)

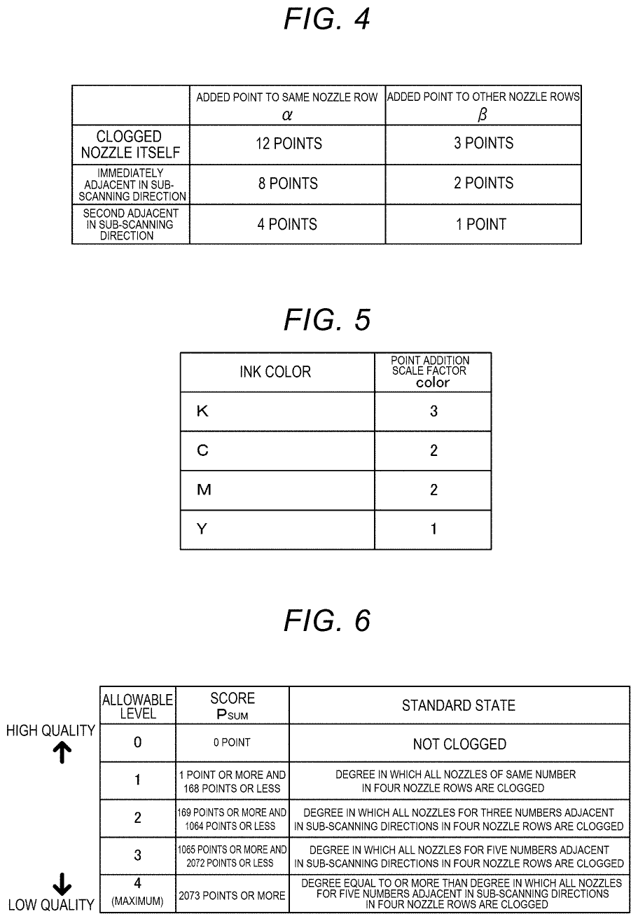

In Expression (1), a is a sum of a score of the clogged nozzle itself and a score indicating influence due to other clogged nozzles in the nozzle row to which the clogged nozzle belongs. The score is specifically explained with reference to FIG. 4. For example, when a certain nozzle is clogged, an added point of 12 points is allocated to the clogged nozzle itself. As clogged nozzles are closer to each other in the same nozzle row, it is more easily recognized by the user that pixels are missing in a print. Accordingly, as shown in FIG. 4, in the nozzle row to which the clogged nozzle belongs, 8 points smaller than an added point to the clogged nozzle itself are allocated to nozzles immediately adjacent to the clogged nozzle in the sub-scanning direction, that is, immediately adjacent to the clogged nozzle on both of upstream and downstream in the conveying direction of the printing medium. Further, in the nozzle row to which the clogged nozzle belongs, 4 points smaller than the added point of the immediately adjacent nozzles are allocated to nozzles second adjacent to the clogged nozzles in the sub-scanning direction based on the clogged nozzles.

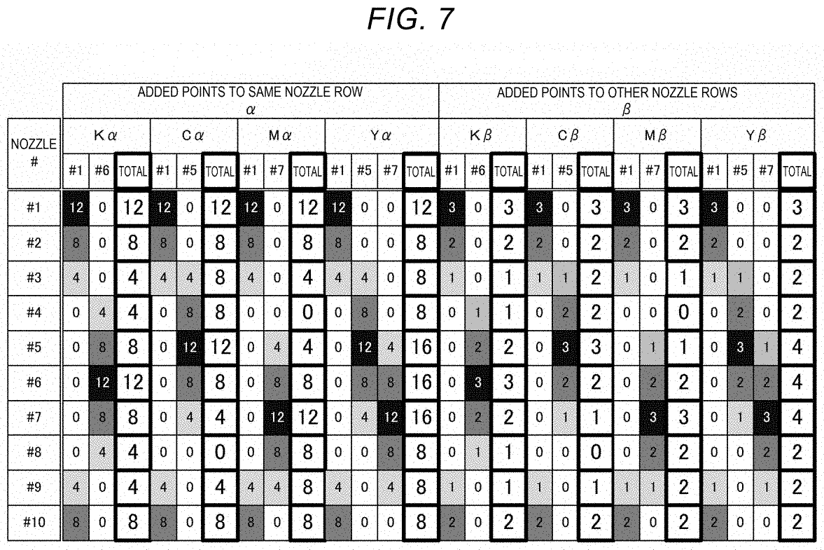

For example, when the nozzles are clogged as shown in FIG. 3, the added points α allocated to the clogged nozzles and the nozzles around the clogged nozzles are explained with reference to FIG. 7. For example, a first nozzle in the K row is focused as one of the clogged nozzles. Since K #1 is clogged, 12 points are allocated to K #1 itself, 8 points are allocated to K #10 and K #2, which are nozzles immediately adjacent to K #1 in the K row, and 4 points are allocated to K #9 and K #3, which are nozzles second adjacent to K #1. In this embodiment, a nozzle #1 and a nozzle #10 are in a relation of ejecting ink droplets to adjacent pixels in the sub-scanning direction on a print. Therefore, the nozzle #1 and the nozzle #10 are treated as adjacent nozzles. In this way, whether nozzles are adjacent is determined according to whether pixels are adjacent on the print and does not always depend on whether the nozzles are adjacent on the nozzle plate. Accordingly, if an image forming method changes according to a printing mode or the like, it is likely that adjacent nozzles change. When K #6 is focused, since K #6 is clogged, 12 points are allocated to K #6 itself, 8 points are allocated to K #5 and K #7, which are nozzles immediately adjacent to K #6 in the K row, and 4 points are allocated to K #4 and K #8, which are nozzles second adjacent to K #6. As shown in FIG. 7, the added point α to the same nozzle row is represented by a total of an added point allocated to K #1 and an added point allocated to K #6. In this example, since four nozzles are present between K #1 and K #6, the added point α is not affected by clogging of K #1 and K #6. That is, Kα#1 is 12 points, which are a total of an added point of 12 points indicating that K #1 is clogged and an added point of 0 point indicating influence of the clogging of K #6 on K #1. Kα#6 is also 12 points.

In the example shown in FIG. 3, Y #1, Y #5, and Y #7 are clogged in the Y row. Y #5 and Y #7 are adjacent across one nozzle. Accordingly, as shown in FIG. 7, Y #5 and Y #7 are not affected by an added point due to the clogging of Y #1. However, Y #5 and Y #7 are affected by an added point due to the clogging of the Y #5 and Y #7. Therefore, Yα#5 is 16 points and Yα#7 is also 16 points. Since Y #1 is not affected by an added point due to Y #5 and an added point due to Y #6, Yα#1 is 12 points. Since pixel missing is more easily recognized on the print as clogged nozzles are closer to each other, a score is set to be larger than when the clogged nozzles are apart from each other.

In Expression (1), when certain one nozzle is clogged, β is a score of three nozzles having the same number as the clogged nozzle in three rows other than a row to which the clogged nozzle belongs. The score is specifically explained with reference to FIGS. 4 and 7. As shown in FIG. 4, in nozzle rows other than the row to which the clogged nozzle belongs, added points of 3 points, 2 points, and 1 point are respectively allocated to nozzles having the same number as the number of the clogged nozzle, nozzles immediately adjacent to the nozzles having the same number in the sub-scanning direction, and nozzles second adjacent to the nozzles having the same number in the sub-scanning direction.

When K #1 is focused, since K #1 is clogged, 3 points are allocated to K #1 itself, 2 points are allocated to K #10 and K #2, which are nozzles immediately adjacent to K #1 in the K row, and 1 point is allocated to K #9 and K #3, which are nozzles second adjacent to K #1. When K #6 is focused, since K #6 is clogged, 3 points are allocated to K #6 itself, 2 points are allocated to K #5 and K #7, which are nozzles immediately adjacent to K #6 in the K row, and 1 point is allocated to K #4 and K #8, which are nozzles second adjacent to K #6. As shown in FIG. 7, the added point β to the other nozzle rows is represented by a total of an added point allocated to K #1 and an added point allocated to K #6. That is, Kβ #1 is 3 points, which is a total of an added point of 3 points indicating that K #1 is clogged and an added point of 0 point indicating influence of the clogging of K #6 on K #1. Kβ #6 is also 3 points.

Kβ #1 is a value used when first nozzle is clogged in at least any one of the C, M, and Y rows other than the K row and is not a value referred to in order to calculate the score P of K #1. That is, when the score P of K #1 is calculated by Expression (1), a term of Kβ #1 is not included. In the example shown in FIG. 3, since the first nozzles are clogged in the C, M, and Y rows other than the K row, Kβ #1 is used when the scores P of C #1, M #1, and Y #1 are calculated by Expression (1). On the other hand, since the sixth nozzles are not clogged in the rows other than the K row, Kβ #6 is a value not used in calculating the scores P in all the rows.

As explained above, in the example shown in FIG. 3, Y #1, Y #5, and Y #7 are clogged in the Y row. Accordingly, as shown in FIG. 7, Y #5 and Y #7 are not affected by an added point due to the clogging of Y #1. However, Y #5 and Y #7 are affected by an added point due to the clogging of the Y #5 and Y #7. Therefore, Yβ #5 is 4 points and Yβ #7 is also 4 points. Since Y #1 is not affected by an added point due to Y #5 and an added point due to Y #6, Yβ #1 is 3 points.

In Expression (1), color is a point addition scale factor corresponding to an ink color. With a dark ink color having larger contrast with a light color such as white assumed as a color of a printing medium, pixel missing in the case of nozzle clogging is more easily recognized. Accordingly, a larger value is set for a darker color. In the case of this embodiment, as shown in FIG. 5, a scale factor of K (black) is 3, a scale factor of C (cyan) and M (magenta) is 2, and a scale factor of Y (yellow) is 1. Therefore, when it is assumed that the number of clogged nozzles and numbers of the clogged nozzles are the same, a value of the score P is larger when a color of ink ejected the clogged nozzles is dark than when the color is light. As explained below, in this embodiment, when a value of the score P_{SUM} increases exceeding a present allowable level, the user is inquired whether to carry out the eliminating operation. Therefore, if the score P_{SUM} does not increase, the inquiry is not carried out in the first place. The eliminating operation is not carried out either. Accordingly, the processor 10 can more easily determine to eliminate the clogging of the nozzle when the color of the ink ejected from the clogged nozzle is dark than when the color is light.

In this way, the processor 10 calculates the score P about the clogged nozzles. In the case of the example shown in FIG. 3, the following nine scores are calculated.

P of K #1=(Kα #1+Cβ #1+Mβ #1+Yβ #1)×3=(12+3+3+3)×3=63

P of C #1=(Cα #1+Kβ #1+Mβ #1+Yβ #1)×2=(12+3+3+3)×2=42

P of M #1=(Mα #1+Kβ #1+Cβ #1+Yβ #1)×2=(12+3+3+3)×2=42

P of Y #1=(Yα #1+Kβ #1+Cβ #1+Mβ #1)×1=(12+3+3+3)×1=21

P of K #6=(Kα #6+Cβ #6+Mβ #6+Yβ #6)×3=(12+2+2+4)×3=60

P of C #5=(Cα #5+Kβ #5+Mβ #5+Yβ #5)×2=(12+2+1+4)×2=38

P of M #7=(Mα #7+Kβ #7+Cβ #7+Yβ #7)×2=(12+2+1+4)×2=38

P of Y #5=(Yα #5+Kβ #5+Cβ #5+Mβ #5)×1=(16+2+3+1)×1=22

P of Y #7=(Yα #7+Kβ #7+Cβ #7+Mβ #7)×1=(16+2+1+3)×1=22

Therefore, in the case of this example, the score P_{SUM} is calculated as 348 points by totaling the nine scores P. In this way, every time the nozzle inspection is performed, the processor 10 calculates the score P_{SUM} based on a result of the nozzle inspection.

When clogging of the nozzles is detected, the processor 10 determines based on a state of the clogging of the nozzles and requested printing quality whether to eliminate the clogging of the nozzles. When determining based on the state of the clogging of the nozzles and the requested printing quality to eliminate the clogging of the nozzles, the processor 10 causes the eliminating mechanism to eliminate the clogging of the nozzles during printing of a printing job. When determining not to eliminate the clogging of the nozzles, the processor 10 does not cause the eliminating mechanism to eliminate the clogging of the nozzles during the printing of the printing job. In this embodiment, the score P_{SUM} indicates the state of the clogging of the nozzles. An allowable level explained below indicates printing quality requested by the user.

In this embodiment, as shown in FIG. 6, the allowable level is divided into five stages. A level 4 corresponds to a state in which the state of the clogging is most worsened. Scores set as thresholds of level divisions are as shown in FIG. 6. A level 0 is a state in which clogging does not occur. A level 1 assumes, as a standard, a state of a degree in which all nozzles of the same number are clogged in the CMYK four nozzle rows. A level 2 assumes, as a standard, a state of a degree in which all nozzles for three numbers adjacent in the sub-scanning direction in the four nozzle rows are clogged. A level 3 assumes, as a standard, a state of a degree in which all nozzles for five numbers adjacent in the sub-scanning direction in the four nozzle rows are clogged. The level 4 assumes a state exceeding the state of the level 3.

Every time default page printing is executed, the processor 10 performs the nozzle inspection and calculates the score P_{SUM} based on an inspection result. The processor 10 compares the score P_{SUM} calculated from a result of the latest nozzle inspection and a level to which the score P_{SUM} calculated from a result of the nozzle inspection performed last time belongs, that is, a present allowable level. When the score of this time is equal to or smaller than an upper limit score of the present allowable level, that is, when the present situation is not a situation in which the state of the clogging of the nozzles is worsened exceeding a range of the present allowable level, the processor 10 does not inquire the user whether to eliminate the clogging and does not carry out the eliminating operation. The processor 10 updates the allowable level to a level corresponding to the score P_{SUM} of this time.

When the score of this time is larger than the upper limit score of the present allowable level, that is, the state of the clogging of the nozzles is worsened more than the allowable level, until the allowable level reaches the maximum, that is, the level 4, before eliminating the clogging of the nozzles, the processor 10 inquires the user whether to eliminate the clogging of the nozzles. That is, the processor 10 inquires the user and causes the user to select whether to eliminate the clogging of the nozzles. For example, the processor 10 causes the UI section 60 to display a message for urging the user to visually check the immediately preceding print and a message for urging the user to select whether to carry out the eliminating operation. For example, the processor 10 may display the standards of the levels shown in FIG. 6 on the UI section 60 and notify a present state of the clogging to the user and display a message for urging the user to select whether to carry out the eliminating operation.

When the user operates the UI section 60 and selects not to perform the eliminating operation, the processor 10 continues the printing without performing the eliminating operation. When the user selects not to perform the eliminating operation, it can be regarded that the user accepts and allows the present printing quality. Therefore, the processor 10 regards that a level equal to or lower than a level in which the present score is included satisfies the printing quality requested by the user and the level in which the present score is included is a maximum level (an allowable level) allowed by the user among the five levels. Accordingly, for example, when the score P_{SUM} of a result of a nozzle inspection of the next time is included in the allowable level or a level (on a high quality side) smaller than the allowable level, the processor 10 does not inquire the user and does not execute the eliminating operation. Therefore, a trouble is reduced for the user compared with a configuration in which the processor 10 always inquires the user whether to carryout the eliminating operation when the score P_{SUM} exceeds a predetermined fixed standard as in the past. Since the eliminating operation is not performed against the intention of the user, it is possible to prevent a time and ink from being consumed for the eliminating operation.

When the user selects not to perform the eliminating operation and the score P_{SUM} of this time exceeds the upper limit score of the present allowable level, the processor 10 increases the allowable level. Increasing the allowable level as shown in FIG. 6 means updating the requested printing quality to a low quality side.

When the user operates the UI section 60 and selects to perform the eliminating operation, the processor 10 performs the eliminating operation. The processor 10 repeats the eliminating operation until the state of the clogging of the nozzles is improved in a nozzle inspection performed after the eliminating operation or the processor 10 determines that the state of the clogging of the nozzles is not improved by the eliminating operation and the eliminating operation is an error. Therefore, the score P_{SUM} calculated from a result of a nozzle inspection after the eliminating operation is not an error and is completed is a value smaller than the score P_{SUM} before the eliminating operation. If the eliminating operation is not an error, the processor 10 resumes the printing after the eliminating operation is completed. If the eliminating operation is an error, the processor 10 advises the user to have the printing apparatus 100 repaired or replace the printing head 20.

When the allowable level updated according to the score P_{SUM} of the last time reaches the level 4, it can be regarded that the user have allowed the state of the clogging of the nozzles without carrying out the eliminating operation until the allowable level reaches the level 4. Accordingly, even if the score P_{SUM} of this time is larger than the score P_{SUM} of the last time, the processor 10 does not inquire the user whether to carry out the eliminating operation and does not carry out the eliminating operation. Therefore, even if the state of the clogging is a bad state, the processor 10 does not carry out the eliminating operation taking into account the intention of the user. Accordingly, a trouble is reduced for the user compared with a configuration in which the processor 10 always inquires the user whether to carry out the eliminating operation when the score P_{SUM} exceeds a predetermined fixed standard as in the past. A time for waiting for the user to select not to perform the eliminating operation can be saved. Since the eliminating operation is not performed against the intention of the user, it is possible to prevent a time and ink from being consumed for the eliminating operation.

As explained above, according to this embodiment, according to various situations such as a situation in which it is desired to improve printing quality with the eliminating operation even if a time and ink are consumed and a situation in which it is desired to obtain a print early even if the printing quality is low, it is possible to flexibly change, according to the intention and tendency of use of the user, selection about whether to carry out the inquiry of the eliminating operation.

In this embodiment, the nozzle inspection is carried out during the printing. “During the printing” is not limited to a period in which ink ejection is actually performed and means a period from a start to completion of image formation conforming to the printing job. Therefore, “during the printing” can include “during conveyance the printing medium” and the like. Every time default page printing is performed, the nozzle inspection and the eliminating operation are performed before printing of the next page is started. After the nozzle inspection and the eliminating operation end, the subsequent page is printed. The user can obtain a print produced by carrying out such nozzle inspection processing during the printing.

Even when determining not to eliminate the clogging of the nozzles during the printing, the processor 10 can eliminate the clogging of the nozzles after printing of a printing job being executed is completed. For example, the processor 10 can perform the nozzle inspection and the eliminating operation at timing instructed by the user. For example, the processor 10 may perform the nozzle inspection and the eliminating operation when a state in which printing is not executed continues for a long time or may perform the nozzle inspection and the eliminating operation at timing when the printing apparatus is turned on.

As explained above, the score P_{SUM} calculated based on the position of the clogged nozzle, the color of the ink ejected by the clogged nozzle, or the like may be set as an indicator indicating the state of the clogging or the number of clogged nozzles or a positional relation among the clogged nozzles may be directly set as an indicator indicating the state of the clogging. For example, the printing quality is more easily deteriorated as the number of clogged nozzles is larger. About the score P_{SUM} calculated by adding up the scores P calculated by the above Expression (1), when an example in which β is a fixed value is assumed and only a certain nozzle row is focused, a value of the score P_{SUM} is larger as the number of clogged nozzles is larger. In this embodiment, unless the score P_{SUM} increases exceeding the present allowable level, the processor 10 does not inquire whether to carry out the eliminating operation and does not carry out the eliminating operation. Therefore, as the number of clogged nozzles is larger, the processor 10 more easily determines to eliminate the clogging of the nozzles.

For example, the printing quality is more easily deteriorated as a continuous number of clogged nozzles is larger. In this embodiment, a larger score is added as a continuous number of clogged nozzles in the same nozzle row is larger, that is, a continuous number of clogged nozzles in the sub-scanning direction is larger. Specifically, for example, a case in which fifth and seventh nozzles in the Y row are clogged (not continuous) (referred to as case 1) and a case in which fifth and sixth nozzles in the Y row are continuously clogged (referred to as case 2) are examined. It is assumed that, except that two nozzles are clogged in the Y row, the nozzles in the other rows are not clogged. In the case 1, the score P of Yα#5 and the score P of Yα#7 are respectively 16 points (see Expression (1) and FIG. 7). In the case 2, the score P of Yα#5 and the score P of Yα#6 are respectively 20 points. Accordingly, the score P_{SUM} of the case 1 is 32 points and the score P_{SUM} of the case 2 is 40 points. Therefore, the score P_{SUM} is a larger value in the case 2 than in the case 1. As explained above, in this embodiment, unless the score P_{SUM} increases exceeding the present allowable level, the processor 10 does not inquire about the eliminating operation and, as a result, does not perform the eliminating operation. Accordingly, the processor 10 more easily determines to eliminate the clogging of the nozzles as the continuous number of clogged nozzles is larger. For example, when the nozzles are disposed such that, for example, the nozzles (which may nozzles for ejecting inks of the same color or inks of different colors) continuously disposed side by side in the main scanning direction eject ink to not the same pixels but pixels continuous in the main scanning direction on the print unlike this embodiment, the printing quality is more easily deteriorated as the number of clogged nozzles is larger not only in the direction in which the nozzle rows extend (the sub-scanning direction) but also the direction in which the nozzle rows are disposed side by side (the main scanning direction). Accordingly, the processor 10 more easily determines to eliminate the clogging of the nozzles as the continuous number of clogged nozzles is larger.

For example, the printing quality is more easily deteriorated as the number of nozzles clogged in the same position in the sub-scanning direction is larger. In the example shown in FIG. 3, the first nozzles are clogged in all of the four rows of K, C, M, and Y. On the other hand, among the sixth nozzles, only the sixth nozzle in the K row is clogged. Therefore, in this case, in pixels formed by the first nozzles and pixels formed by the sixth nozzles, clogging of the first nozzles is more easily recognized by the user. When a calculation result of the nine scores P is referred to, it is indicated that a sum of the score P of K #1, the score P of C #1, the score P of M #1, and the score P of Y #1 is larger than the score P of K #6. As explained above, in this embodiment, if the score P_{SUM} does not increase exceeding the present allowable level, the inquiry about whether to carry out the eliminating operation is not carried out in the first place. Accordingly, the eliminating operation is not carried out either. Therefore, the processor 10 more easily determines to eliminate the clogging of the nozzles as the number of nozzles clogged in the same position in the sub-scanning direction is larger.

### (2) Nozzle Inspection Processing

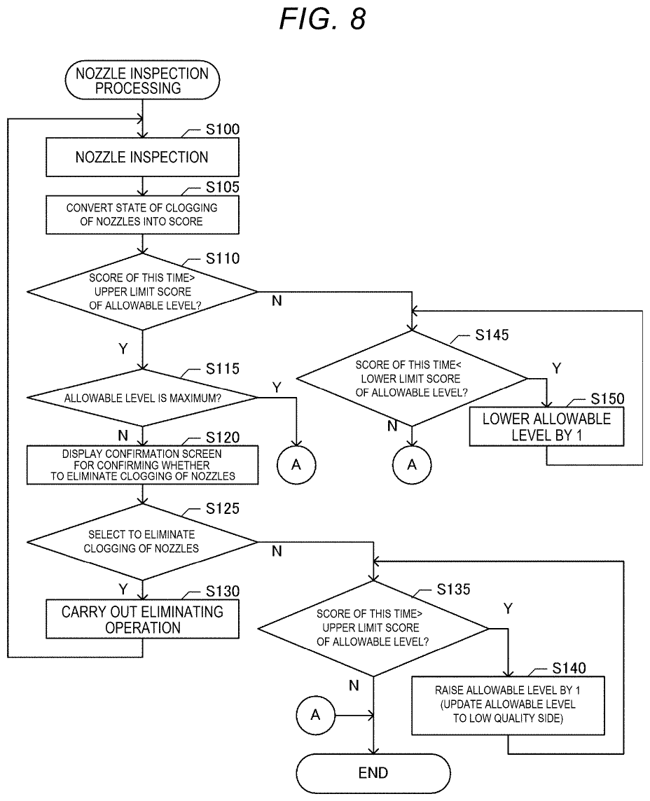

FIG. 8 is a flowchart showing nozzle inspection processing. The processing is executed by the processor 10 every time printing of a default number of pages is executed. When the nozzle inspection processing is started, the processor 10 carries out a nozzle inspection (step S100). That is, the processor 10 controls the detecting mechanism 40 to carry out the nozzle inspection and acquires identification information of clogged nozzles. Subsequently, the processor 10 converts a state of the clogging of the nozzles into a score (step S105). That is, the processor 10 calculates, based on a result of the nozzle inspection in step S100, the scores P of the clogged nozzles according to the above Expression (1) and adds up the scores P to thereby calculate the score P_{SUM}.

Subsequently, the processor 10 determines whether the score of this time is larger than an upper limit score of an allowable level (step S110). That is, the processor 10 compares the score P_{SUM} calculated based on a result of the most recent nozzle inspection and an upper limit score of an allowable level set according to the score P_{SUM} calculated based on a result of a nozzle inspection of the last time.

If it is not determined in step S110 that the score of this time is larger than the upper limit score of the allowable level, that is, the state of the clogging of the nozzles is not worsened exceeding a range of the allowable level, the processor 10 updates the allowable level to a level corresponding to the score of this time. That is, the processor 10 determines whether the score of this time is smaller than a lower limit score of the present allowable level (step S145) and, when the score of this time is smaller than the lower limit score, lowers the allowable level by 1 (step S150) and returns to step S145. When not determining in step S145 that the score of this time is smaller than the lower limit score, the processor 10 maintains the present allowable level and ends the nozzle inspection processing. When determined as N in step S110, the processor 10 does not carry out the eliminating operation and does not carry out inquiry about whether to carry out the eliminating operation. That is, even if the score of this time is larger than the score of the last time, if the score of this time is not deteriorated to exceed the upper limit of the present allowable level, the processor 10 does not carry out the inquiry and does not carry out the eliminating operation. Accordingly, a trouble is reduced for the user and a time and ink are not consumed against the intention of the user.

When determining in step S110 that the score of this time is larger than the upper limit score of the allowable level, the processor 10 determines whether the allowable level is the maximum (step S115). When the allowable level is the maximum, the processor 10 ends the nozzle inspection processing. That is, in this case, the processor 10 does not inquire the user whether to carry out the eliminating operation and does not perform the eliminating operation without permission. Accordingly, a trouble is reduced for the user and a time and ink are not consumed against the intention of the user.

When not determining in step S115 that the allowable level is the maximum, the processor 10 displays a confirmation screen for confirming whether to eliminate the clogging of the nozzles (step S120). That is, the processor 10 displays, on the UI section 60, a confirmation screen for causing the user to visually check the immediately preceding print and select whether to carry out the eliminating operation. Subsequently, the processor 10 determines whether the user selects to eliminate the clogging of the nozzles (step S125). That is, the processor 10 determines whether operation for selecting to eliminate the clogging of the nozzles is performed on the UI section 60.

When not determining in step S125 that the user selects to eliminate the clogging of the nozzles, the processor 10 updates the allowable level to a level corresponding to the score of this time. That is, the processor 10 determines whether the score of this time is larger than the upper limit score of the present allowable level (step S135) and, when the score of this time is larger than the upper limit score, raises the allowable level by one (step S140) and returns to step S135. When not determining in step S135 that the score of this time is larger than the upper limit score, the processor 10 maintains the present allowable level and ends the nozzle inspection processing. That is, in this case, since the processor 10 does not perform the eliminating operation, a time and ink are not consumed against the intention of the user.

When determining in step S125 that the user selects to eliminate the clogging of the nozzles, the processor 10 eliminates the clogging of the nozzles (step S130). That is, the processor 10 controls the eliminating mechanism 30 to carry out the eliminating operation. Therefore, only when the state of the clogging of the nozzles exceeds the allowable level of the user, the processor 10 can inquire whether to carry out the eliminating operation and, when the user selects to carry out the eliminating operation, carry out the eliminating operation as intended by the user. After execution of step S130, the processor 10 returns to step S100 and performs the nozzle inspection again.

### (3) Other Embodiments

The embodiment explained above is an example for carrying out the present disclosure. Besides, various embodiments can be adopted. For example, the present disclosure may be applied to a multifunction peripheral including an image reading function and a FAX transmitting function besides a printing function. The printing head only has to be able to perform printing by ejecting the ink from the plurality of nozzles. As ink ejecting scheme, various schemes such as a piezoelectric scheme and a thermal scheme may be adopted.

The clogging of the nozzles may include a situation in which the nozzles are complete clogged and the ink droplets are not ejected at all and a situation in which, although the ink droplets are ejected, an ejection amount and an ejection direction are abnormal.

Types of the inks are not limited to C, M, Y, and K. The present disclosure is applicable in various ink colors. The configuration of the nozzles is not limited to the example in the embodiment. Various configurations of the nozzles can be adopted. The number of ink colors is not limited and may be one, six, and the like.

The detecting mechanism only has to be able to detect clogging of the nozzles. Various configurations of the detecting mechanism can be adopted. Besides the configuration in the embodiment, for example, a configuration for ejecting the ink from the nozzles in a state in which a voltage is applied between the nozzle plate and an electrode on the cap bottom surface and detecting a change in the voltage between the nozzle plate and the electrode to thereby detect clogging of the nozzles may be adopted. For example, a configuration for printing a test pattern for clogging detection on a printing medium, photographing the test pattern after the printing with a camera provided in the carriage or the like, and detecting clogging of the nozzles based on a photographed image may be adopted. A configuration for optically detecting ink droplets ejected from the nozzles may be adopted.

The eliminating mechanism only has to be able to eliminate clogging of the nozzles. Various configurations of the eliminating mechanism can be adopted. As a method of eliminating clogging of the nozzles Nz and recovering an ejection ability, there is a micro vibration operation besides the sucking operation and the flushing operation explained above. The micro vibration operation is operation for, by giving a pressure change of a degree in which the ink droplets are not ejected, moving a free surface of the ink exposed in the nozzles Nz to an ejection side and a drawing side and dispersing thickened ink near the nozzles with agitation. Concerning the sucking operation, the flushing operation, and the micro vibration operation, a degree of recovering the discharge ability of the nozzles Nz is the highest in the sucking operation and the lowest in the micro vibration operation. A consumption amount of the ink in the operations is the largest in the sucking operation and the smallest in the micro vibration operation. Since these eliminating operations have such differences in characteristics, the eliminating operations may be properly used according to a state of the clogging of the nozzles.

In the embodiment, it is assumed that the sucking operation is carried out not in a nozzle unit or a nozzle row unit but for all the nozzles of the nozzle plate. However, the cap may be configured such that the sucking operation can be performed in the nozzle unit or the nozzle row unit. The flushing operation and the micro vibration operation may be carried out in the nozzle unit, may be carried out in the nozzle row unit, or may be carried out for the nozzles of all the nozzle rows. A wiper that is driven by the control by the processor and can wipe the nozzle plate may be provided. A wiping operation by the wiper is performed for the entire nozzle plate.

When clogging of the nozzles is detected, the processor that causes the printing head to perform printing according to the printing job only has to be able to determine based on a state of the clogging of the nozzles and requested printing quality whether to eliminate the clogging of the nozzles. In the embodiment, the requested printing quality is acquired when the user is inquired about printing quality after the nozzle inspection. However, the requested printing quality is not limited to this. For example, printing quality designated by the user for the printing job in print setting may be treated as the requested printing quality. The requested printing quality may be determined according to content of printing data such as photograph data or text data. For example, the processor 10 may be configured to, when the user requests printing at high image quality during printing job generation, carry out the eliminating operation if a present state indicating clogging of the nozzles does not satisfy a state necessary for the printing at the high image quality and not carry out the eliminating operation if the present state of the clogging of the nozzles satisfies the state necessary for the printing at the high image quality. When the user requests printing at standard image quality during the printing job generation, the present state of the clogging of the nozzles and a state necessary for the printing at the standard image quality are compared. The standard image quality is lower than the high image quality. The requested printing quality is not limited to two types of the high image quality and the standard image quality and may be further subdivided.

An indicator indicating a state of the clogging of the nozzles may be directly the number of clogged nozzles. The processor may be configured to, when the number of clogged nozzles is larger than a first threshold, determine to eliminate the clogging of the nozzles. In this case, the first threshold is larger when the printing quality is low than when the printing quality is high. For example, when the requested printing quality is the standard image quality, the number of nozzles (the number of clogged nozzles) for determining to carry out the eliminating operation is larger than when the requested printing quality is the high image quality. Specifically, for example, when the requested printing quality is the standard image quality, the number of nozzles (4×3=12) equivalent to the level 2 shown in FIG. 6 may be adopted as the first threshold. When the requested printing quality is the high image quality, the number of nozzles (4×1=4) equivalent to the level 1 may be adopted as the first threshold. Naturally, the numerical values are examples. The number of nozzles may be set as appropriate according to an array of the nozzles in the printing head.

The processor may be configured to, when the continuous number of clogged nozzles is larger than a second threshold, determine to eliminate the clogging of the nozzles. In this case, the second threshold is larger when the printing quality is low than when the printing quality is high. The continuous number of clogged nozzles may be assumed to be at least one of the number of clogged nozzles continuous in the sub-scanning direction and the number of clogged nozzles continuous in the main scanning direction. As an example, the continuous number of clogged nozzles in the same nozzle row is set as an indicator. When the requested printing quality is the standard image quality, for example, the number of nozzles (three) equivalent to the level 2 shown in FIG. 2 may be adopted as the second threshold. When the requested printing quality is the high image quality, the number of nozzles (one) equivalent to the level 1 may be adopted as the second threshold.

The processor may be configured to, when the number of nozzles clogged in the same position in the sub-scanning direction is larger than a third threshold, determine to eliminate the clogging of the nozzles. In this case, the third threshold is larger when the printing quality is low than when the printing quality is high. For example, when the requested printing quality is the standard image quality, three may be adopted as the third threshold. When the requested printing quality is the high image quality, two may be adopted as the third threshold.

The indicator indicating the state of the clogging of the nozzles may be the score P_{SUM} calculated as in the embodiment. Added points for calculating the score P_{SUM} may be adjusted as appropriate according to an array and the number of nozzles in the printing head, printing conditions, and the like. For example, when the nozzles are configured to eject the ink to pixels that are not adjacent on the nozzle plate but are adjacent on a print, points may be adjusted to be added assuming that the nozzles are adjacent nozzles. Conversely, when the nozzles are configured to eject the ink to pixels that are adjacent on the nozzle plate but are separated from one another on the print, points may be adjusted to be not added assuming that the nozzles are adjacent nozzles.

The nozzle inspection processing shown in FIG. 8 may be executed during printing or may be executed at a time other than during printing. For example, the processor 10 may be configured to carry out the nozzle inspection processing before printing, print a test pattern, and cause the user to select whether to carry out the eliminating operation.

As in the embodiment, the processor 10 is not limited to inquire the user whether to eliminate the clogging. In a situation in which a state of the clogging of the nozzles is worsened exceeding the range of the present allowable level, the processor 10 may automatically start the eliminating operating without performing the inquiry. In this case, the user can instruct a stop of the eliminating operation during the eliminating operation. When the stop is instructed, the printing apparatus may stop the eliminating operation and resume the printing and change the present allowable level.

Further, the present disclosure can be applied as a program and a method executed by a computer. The system, the program, and the method explained above are realized as an independent apparatus in some cases and are realized using components included in a plurality of apparatuses in other cases. The system, the program, and the method include various forms. The system, the program, and the method can be changed as appropriate, for example, a part of the system, the program, and the method is software and a part of the system, the program, and the method is hardware. Further, an invention is established as a recording medium of a program for controlling the system. Naturally, the recording medium for the program may be a magnetic recording medium or may be a semiconductor memory. All recording media to be developed in future can be considered completely the same.

What is claimed is:

1. A printing apparatus comprising:
a printing head configured to eject ink from a plurality of nozzles to perform printing;
a detecting mechanism configured to detect clogging of the nozzles;
an eliminating mechanism configured to eliminate the clogging of the nozzles; and
a processor configured to cause the printing head to perform the printing according to a printing job, wherein
when the clogging of the nozzles is detected, the processor determines based on a state of the clogging of the nozzles and requested printing quality whether to eliminate the clogging of the nozzles, when determining to eliminate the clogging of the nozzles, causes the eliminating mechanism to eliminate the clogging of the nozzles during the printing of the printing job, and, when determining not to eliminate the clogging of the nozzles, does not cause the eliminating mechanism to eliminate the clogging of the nozzles during the printing of the printing job.

2. The printing apparatus according to claim 1, wherein the processor more easily determines to eliminate the clogging of the nozzles as a number of the clogged nozzles is larger.

3. The printing apparatus according to claim 1, wherein
when the number of the clogged nozzles is larger than a first threshold, the processor determines to eliminate the clogging of the nozzles, and
the first threshold is larger when the printing quality is low than when the printing quality is high.

4. The printing apparatus according to claim 1, wherein the processor more easily determines to eliminate the clogging of the nozzles as a continuous number of the clogged nozzles is larger.

5. The printing apparatus according to claim 1, wherein
when a continuous number of the clogged nozzles is larger than a second threshold, the processor determines to eliminate the clogging of the nozzles, and
the second threshold is larger when the printing quality is low than when the printing quality is high.

6. The printing apparatus according to claim 1, wherein the processor more easily determines to eliminate the clogging of the nozzles as a number of the nozzles clogged in a same position in a sub-scanning direction is larger.

7. The printing apparatus according to claim 1, wherein
when a number of the nozzles clogged in a same position in a sub-scanning direction is larger than a third threshold, the processor determines to eliminate the clogging of the nozzles, and
the third threshold is larger when the printing quality is low than when the printing quality is high.

8. The printing apparatus according to claim 1, wherein the processor more easily determines to eliminate the clogging of the nozzles when a color of an ink ejected from the clogged nozzles is dark than when the color is light.

9. The printing apparatus according to claim 1, wherein
the processor inquires, before eliminating the clogging of the nozzle, a user whether to eliminate the clogging of the nozzles and determines the requested printing quality based on an answer to the inquiry.

10. The printing apparatus according to claim 9, wherein the processor eliminates the clogging of the nozzles when instructed to eliminate the clogging of the nozzles by the answer to the inquiry and updates the requested printing quality to a lower quality side without eliminating the clogging of the nozzles when instructed not to eliminate the clogging of the nozzles by the answer to the inquiry.

11. The printing apparatus according to claim 1, wherein, when determining not to eliminate the clogging of the nozzles, the processor eliminates the clogging of the nozzles after printing of the printing job being executed is completed.

12. The printing apparatus according to claim 1, wherein the requested printing quality is printing quality set in the printing job.

13. A printing apparatus comprising:
a printing mechanism configured to perform printing;
a detecting mechanism configured to detect an abnormality of the printing mechanism that deteriorates quality of the printing;
an eliminating mechanism configured to eliminate the abnormality; and
a processor configured to cause the printing mechanism to perform the printing according to a printing job, wherein
when the abnormality is detected by the detecting mechanism, the processor causes the eliminating mechanism to eliminate the abnormality at timing based on a state of the abnormality and requested printing quality.
